(19) United States
(12) Patent Application Publication
(10) Pub. No.: US 2026/0140914 A1
(43) Pub. Date: May 21, 2026

(54) MULTI-FUNCTION USB FLASH DRIVE

(71) Applicants: Tekism Co., Ltd.,, Suzhou (CN); Tekism Inc., SAN FRANCISCO, CA (US)

(72) Inventors: Zhiwen PENG, Suzhou (CN); Chengjian CHAI, Suzhou (CN)

(73) Assignees: Tekism Co., Ltd.,, Suzhou, JS (CN); Tekism Inc., SAN FRANCISCO, CA (US)

(21) Appl. No.: 19/207,931

(22) Filed: May 14, 2025

(30) Foreign Application Priority Data
Nov. 18, 2024 (CN) 202422804732.8

(51) Int. Cl. G06F 13/42; G06F 13/38

(52) U.S. Cl. CPC G06F 13/4282; G06F 13/382; G06F 2213/0042

(57) ABSTRACT

The present disclosure relates to a multi-function flash drive. The flash drive includes: a housing having an opening at a first end and defining an interior cavity; a USB flash drive body disposed within the housing, wherein the USB flash drive body comprises a USB connector at one end facing the opening; a slider assembly mounted to the housing and configured to translate the USB flash drive body between a retracted position and an extended position along the interior of the housing, wherein the USB connector is positioned inside the housing in the retracted position, and wherein the USB connector projects through the opening in the extended position; and a tool secured to a second end of the slider assembly opposite the USB flash drive body.

### CROSS-REFERENCE TO RELATED APPLICATION

This application claims priority to Chinese Patent Application No. 202422804732.8, filed on Nov. 18, 2024, the entire content of which is incorporated herein by reference for all purposes.

### TECHNICAL FIELD

The present disclosure relates to the technical field of flash drives, and more particularly to a multi-function USB flash drive.

### BACKGROUND

Flash drives are compact, high-capacity mobile storage devices that utilize USB connectors for plug-and-play functionality with computers and other electronic devices. While widely used due to their portability, conventional flash drives typically offer limited functionality, lacking integration with any other tools. As a result, users may experience inconvenience when needing such tools in emergency or everyday situations.

### SUMMARY

The present disclosure aims to provide a multi-function flash drive that integrates a tool without compromising the original storage functionality, thereby expanding the utility and convenience of the flash drive.

According to a first aspect of the application, a flash drive may include a housing having an opening at a first end and defining an interior cavity. A USB flash drive body may be disposed within the housing, wherein the USB flash drive body may include a USB connector at one end facing the opening. A slider assembly may be mounted to the housing and may be configured to translate the USB flash drive body between a retracted position and an extended position along the interior of the housing, wherein the USB connector may be positioned inside the housing in the retracted position, and may project through the opening in the extended position. A tool may be secured to a second end of the slider assembly opposite the USB flash drive body.

According to a second aspect of the application, a flash drive may include a housing defining an interior cavity and an opening at a first end. A USB connector may be movably disposed within the housing and oriented toward the opening. A sliding mechanism may be configured to translate the USB connector between a retracted position, in which the USB connector may be enclosed within the housing, and an extended position, in which the USB connector may protrude through the opening. A tool may be integrally connected to a portion of the sliding mechanism, wherein the tool may be accessible at a second end of the housing opposite the opening and may be configured to perform a non-data-related physical function.

According to a third aspect of the application, a flash drive may include a housing having an opening at one end and an internal channel extending along a longitudinal axis, a USB storage assembly positioned within the internal channel and including a USB connector aligned with the opening, and a user-actuated slider disposed on an exterior surface of the housing. The slider may be movable between a first position and a second position to cause the USB connector to move between a stored position within the housing and an exposed position extending from the opening. The user-actuated slider may include a rotatable shaft configured to convert rotational input from a user into linear translation of the USB storage assembly.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic view of the multi-function flash drive with the USB connector in a retracted position.

FIG. 2 is a schematic view of the multi-function flash drive with the USB connector in an extended position.

FIG. 3 is a cross-sectional view of the multi-function flash drive.

FIG. 4 is a cross-sectional view of the housing.

FIG. 5 is an exploded view of the multi-function flash drive.

FIG. 6 is a cross-sectional view of the end cap.

FIG. 7 is a schematic view showing the end cap mounted on the manually rotatable shaft.

### DETAILED DESCRIPTION

The specific embodiments of the present disclosure are described in detail hereinafter with reference to the accompanying drawings. In the description of the embodiments of the present disclosure, for ease of illustration, the schematic structural views are not partially enlarged according to a typical scale, and the schematic views are given for exemplary purpose only, which do not limit the protection scope of the present disclosure. In addition, in practice, a three-dimension spatial size in terms of length, width, and depth needs to be included.

Some embodiments of the present disclosure provide a method for forming a package structure. Hereinafter, the method is described with reference to the accompanying drawings.

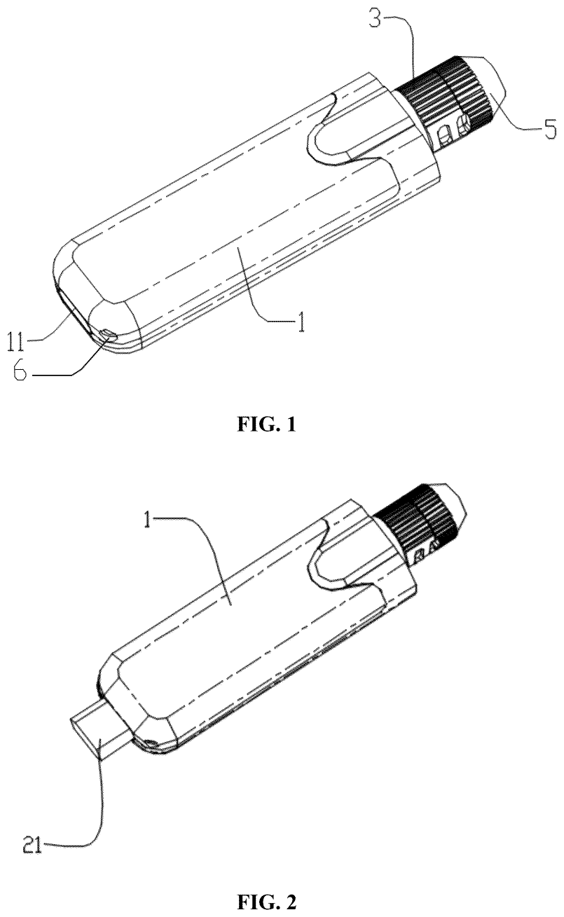

Referring to FIGS. 1-3, a multi-function flash drive is provided. The multi-function flash drive includes a housing 1, a USB flash drive body 2, a slider assembly 3, and a tool 4. The housing 1 has an opening 11 formed at a first end and defining an interior cavity in communication with the opening 11. The USB flash drive body 2 is disposed within the housing 1, with a USB connector 21 integrally provided at one end of the USB flash drive body 2 facing the opening 11. The slider assembly 3 is mounted to an end of the housing 1 opposite the opening 11 and is configured to drive the USB flash drive body 2 to slide within the housing 1, such that the USB connector 21 extends through or retracts into the housing 1 via the opening 11. The tool 4 is mounted to an end of the slider assembly 3 opposite the USB flash drive body 2.

The slider assembly 3 is configured to drive the USB flash drive body 2 to slide within the housing 1, enabling the USB connector 21 to extend outward from or retract into the housing 1 through the opening 11. In some examples, the slider assembly 3 is a rotary assembly configured to rotate while driving the USB flash drive body 2 to slide within the housing 1. When the USB connector 21 is not in use, the USB connector 21 can be retracted into the housing 1 to provide protection. When use of the USB connector 21 is required, the USB connector 21 can be extended outward from the housing 1 to allow insertion into a computer or other external device. This configuration effectively enhances the durability and service life of the USB connector 21. Additionally, by mounting the tool 4 on the slider assembly 3, the multi-function flash drive provides added functionality without interfering with normal operation of the USB connector 21, thereby expanding the applicability and convenience of the flash drive. By way of example, the tool 4 may be a small tool such as a glass breaker or a screwdriver. In one or more examples, the small tool can also be an adaptor configured to connect or secure another mechanical tool.

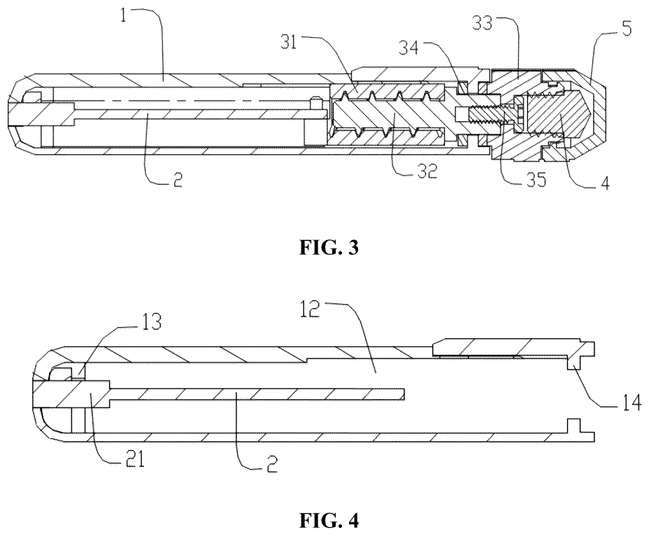

In some embodiments, as shown in FIGS. 3-4, the housing 1 is provided with a sliding cavity 12. A guide protrusion 13 is disposed on an inner wall of the sliding cavity 12 near the opening 11. The guide protrusion 13 defines a guide slot through which the USB connector 21 passes. The arrangement of the guide protrusion 13 and the guide slot is configured to guide the movement of the USB connector 21, allowing the USB connector 21 to smoothly extend out of and retract into the housing 1 through the opening 11.

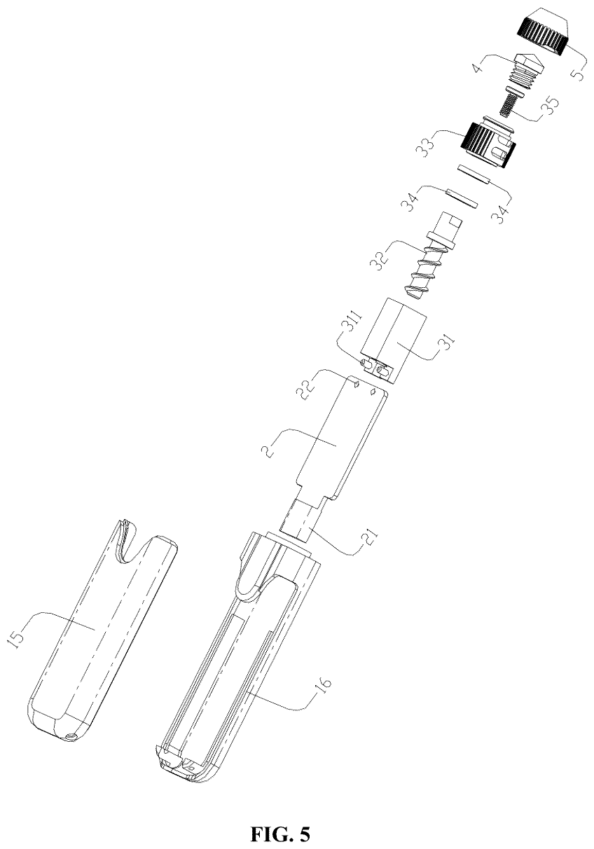

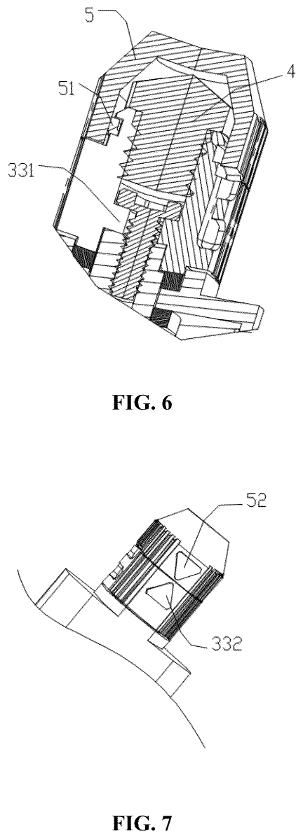

In some embodiments, as shown in FIGS. 5-6, the slider assembly 3 includes a sliding seat 31, a threaded shaft 32, and a manually rotatable shaft 33. The sliding seat 31 is shaped to be compatible with the sliding cavity 12 and is configured to slide along the sliding cavity 12. One end of the sliding seat 31 is connected to the USB flash drive body 2, while the other end is threadedly engaged with the threaded shaft 32. The manually rotatable shaft 33 abuts an end of the housing 1 opposite the opening 11 and is coaxially connected to the threaded shaft 32. In operation, rotation of the manually rotatable shaft 33 drives the threaded shaft 32 to rotate synchronously. Through the threaded engagement between the threaded shaft 32 and the sliding seat 31, this rotation is converted into linear movement of the sliding seat 31 within the housing 1, thereby enabling linear translation of both the USB flash drive body 2 and the USB connector 21.

Specifically, the sliding seat 31 includes a seat body. One end of the seat body is provided with at least one positioning pin 311 configured to engage with a corresponding hole 22 formed in the USB flash drive body 2. The opposite end of the seat body includes a threaded bore configured to engage with the threaded shaft 32. During assembly, the USB flash drive body 2 is coupled to the seat body by inserting the positioning pin 311 downward into the corresponding hole 22. It should be noted that the engagement direction between the USB flash drive body 2 and the sliding seat 31 is perpendicular to the sliding direction of the sliding seat 31, thereby ensuring that the positioning pin 311 remains securely engaged within the corresponding hole 22 during movement of the sliding seat 31, preventing accidental disengagement during operation.

In some embodiments, an annular protrusion 14 is disposed on an inner wall of the sliding cavity 12 at a side opposite the opening 11. The threaded shaft 32 and the manually rotatable shaft 33 are respectively positioned on opposite sides of the annular protrusion 14, with spacers 34 disposed between each of the shafts and the annular protrusion 14. The annular protrusion 14 is configured to limit the axial positions of the threaded shaft 32 and the manually rotatable shaft 33 within the housing 1. During assembly, the threaded shaft 32 and the manually rotatable shaft 33 may be inserted into the housing 1 from opposite ends of the housing 1, thereby simplifying the assembly process.

In some embodiments, the manually rotatable shaft 33 includes a shaft body with a through-hole formed coaxially along its axis. An internal shoulder 331 is integrally formed on an inner surface of the through-hole and is configured to abut the threaded shaft 32. Furthermore, the manually rotatable shaft 33 is fixed to the threaded shaft 32 by a screw 35. For example, the screw 35 is inserted through the through-hole and threaded into the threaded shaft 32, with the head of the screw 35 abutting the internal shoulder 331. When the shaft body is rotated, the screw 35 rotates synchronously, thereby driving the threaded shaft 32 to rotate synchronously. As the threaded shaft 32 rotates, the sliding seat 31, being guided and limited by the sliding cavity 12, converts the rotational motion of the threaded shaft 32 into linear movement.

In some embodiments, the tool 4 is removably connected to the manually rotatable shaft 33. For example, the tool 4 may be threadedly engaged within the through-hole of the manually rotatable shaft 33.

In some embodiments, as shown in FIGS. 6-7, an end cap 5 is fitted onto an end of the manually rotatable shaft 33 opposite the USB flash drive body 2, such that the end cap 5 covers the tool 4. The end cap 5 is removably connected to the manually rotatable shaft 33 by a snap-fit structure. For example, a snap block 51 is provided on an inner wall of the end cap 5, and a corresponding snap groove is formed on an outer wall of the manually rotatable shaft 33. When the end cap 5 is mounted onto the manually rotatable shaft 33, rotation of the end cap 5 causes the snap block 51 to engage with the snap groove.

When the tool 4 is to be used, the end cap 5 is rotated to disengage the snap block 51 from the snap groove, allowing the end cap 5 to be removed from the manually rotatable shaft 33. Furthermore, to prevent accidental release of the end cap 5 from the manually rotatable shaft 33 (i.e., unintentional disengagement of the snap block 51 from the snap groove), in some embodiments, a first alignment mark 332 is provided on the surface of the manually rotatable shaft 33, and a second alignment mark 52 is provided on the end cap 5. The snap-fit structure is configured such that the snap block 51 is positioned outside the snap groove, placing the snap-fit in a release state, only when the first alignment mark 332 is aligned with the second alignment mark 52. When the tool 4 is not in use, the end cap 5 may be rotated so that the second alignment mark 52 is no longer aligned with the first alignment mark 332, thereby securing the end cap 5 in place.

Additionally or alternatively, to facilitate rotation of the manually rotatable shaft 33 and the end cap 5, an anti-slip texture is provided on outer surfaces of the manually rotatable shaft 33 and the end cap 5.

In some embodiments, the housing 1 includes an upper housing 15 and a lower housing 16 that are detachably connected. The upper housing 15 and the lower housing 16 together define the sliding cavity 12. The split design of the housing 1 facilitates assembly of the components.

In some embodiments, the housing 1 is provided with an indicator light 6 configured to illuminate when the USB connector 21 is inserted into a computer or other external device.

The slider assembly may include a sliding seat, a threaded shaft, and a manually rotatable shaft. The sliding seat may be positioned within the housing and may include a first end and a second end. The first end may be connected to the USB flash drive body, and the second end may be threaded with the threaded shaft. The manually rotatable shaft may abut an end of the housing opposite the opening and may be coaxially secured to the threaded shaft.

The housing may include a sliding cavity shaped to accommodate the sliding seat. An annular protrusion may be positioned on an inner wall of the sliding cavity at a side opposite the opening. The threaded shaft and the manually rotatable shaft may be respectively positioned on opposite sides of the annular protrusion. A spacer may be positioned between the threaded shaft and the annular protrusion, and a spacer may be positioned between the manually rotatable shaft and the annular protrusion.

The sliding cavity may include a guide protrusion disposed on an inner wall of the housing near the opening, wherein the guide protrusion may define a guide slot that directs the USB connector to extend out of or retract into the housing.

The sliding seat may include a seat body. One end of the seat body may include a positioning pin received in a corresponding hole in the USB flash drive body, and another end of the seat body may include a threaded bore engaged with the threaded shaft.

An engagement direction between the positioning pin and the USB flash drive body may be perpendicular to a sliding direction of the sliding seat within the housing.

The manually rotatable shaft may include a shaft body, wherein a through-hole may be coaxially formed in the shaft body. An internal shoulder may be integrally formed on an inner surface of the through-hole and may abut the threaded shaft.

The manually rotatable shaft may be fixed to the threaded shaft by a screw.

The tool may be removably attached to an end of the slider assembly opposite the USB flash drive body, and the tool may include a glass breaker or a screwdriver.

The tool may be threadedly engaged within the through-hole of the manually rotatable shaft.

An end cap may be removably connected to the manually rotatable shaft by a snap-fit. A first alignment mark may be disposed on the manually rotatable shaft, and a second alignment mark may be disposed on the end cap. The end cap may cover the tool when the first alignment mark is not aligned with the second alignment mark, and the snap-fit may be released when the first alignment mark aligns with the second alignment mark.

An outer surface of the manually rotatable shaft or the end cap may include an anti-slip texture.

The housing may include an indicator light configured to illuminate when the USB connector is electrically connected to an external device.

The housing may include an upper housing and a lower housing that may be detachably connected, wherein the upper housing and the lower housing may form the sliding cavity when assembled.

The sliding mechanism may include a threaded shaft and a manually rotatable shaft, wherein rotation of the manually rotatable shaft may cause the threaded shaft to drive the USB connector to translate between the retracted position and the extended position.

The tool may be removably secured to the manually rotatable shaft by a threaded connection and may be configured to be interchangeable.

The flash drive may further include a tool removably secured to an end of the user-actuated slider opposite to the USB storage assembly, wherein the tool may be configured to perform a non-data-related physical function.

An end cap may be removably connected to the end of the user-actuated slider opposite to the USB storage assembly, wherein the end cap may be configured to cover the tool when the tool is not in use.

In addition, terms “comprise,” “include,” and variations thereof used herein in the text of the present disclosure are intended to define a non-exclusive meaning. It should be noted that the terms such as “first,” “second,” and the like in the specifications, claims and the accompanying drawings of the present disclosure are intended to distinguish different objects but are not intended to define a specific order or a definite time sequence. Unless otherwise clearly indicated in the context, it should be understood that the data used in this way can be interchanged under appropriate circumstances. In cases of no conflict, the embodiments and features in the embodiments of the present disclosure may be combined together. Further, in the above description, descriptions of well-known components and techniques are omitted so as not to unnecessarily obscure the inventive concepts of the present disclosure. In various embodiments of the present disclosure, the same or similar parts between the embodiments may be referenced to each other. In each embodiment, the portion that is different from other embodiments is concentrated and described.

Although the present disclosure has been disclosed above with reference to preferred embodiments, these embodiments are not intended to limit the present disclosure but illustrate the present disclosure. Without departing from the spirit and scope of the present disclosure, any person skilled in the art may make possible variations and modifications to the technical solutions based on the method and technical content disclosed herein in this literature. Therefore, any content without departing from the technical solutions of the present disclosure and any simple variation, equivalent replacement and modification made based on the technical essence of the present disclosure shall fall within the protection scope defined by the technical solutions of the present disclosure.

What is claimed is:

1. A flash drive, comprising:
a housing having an opening at a first end and defining an interior cavity;
a USB flash drive body disposed within the housing, wherein the USB flash drive body comprises a USB connector at one end facing the opening;
a slider assembly mounted to the housing and configured to translate the USB flash drive body between a retracted position and an extended position along the interior of the housing, wherein the USB connector is positioned inside the housing in the retracted position, and wherein the USB connector projects through the opening in the extended position; and
a tool secured to a second end of the slider assembly opposite the USB flash drive body.

2. The flash drive of claim 1, wherein the slider assembly comprises: a sliding seat, a threaded shaft, and a manually rotatable shaft;
wherein the sliding seat is positioned within the housing and comprises a first end and a second end;
wherein the first end is connected to the USB flash drive body, and the second end is threaded with the threaded shaft; and
wherein the manually rotatable shaft abuts an end of the housing opposite the opening, and the manually rotatable shaft is coaxially secured to the threaded shaft.

3. The flash drive of claim 2, wherein the housing comprises a sliding cavity shaped to accommodate the sliding seat, and an annular protrusion positioned on an inner wall of the sliding cavity at a side opposite the opening;
wherein the threaded shaft and the manually rotatable shaft are respectively positioned on opposite sides of the annular protrusion;
wherein a spacer is positioned between the threaded shaft and the annular protrusion, and
wherein a spacer is positioned between the manually rotatable shaft and the annular protrusion.

4. The flash drive of claim 3, wherein the sliding cavity comprises a guide protrusion disposed on an inner wall of the housing near the opening, wherein the guide protrusion defines a guide slot that directs the USB connector to extend out of or retract into the housing.

5. The flash drive of claim 2, wherein the sliding seat comprises a seat body;
wherein one end of the seat body comprises a positioning pin received in a corresponding hole in the USB flash drive body, and
wherein another end of the seat body comprises a threaded bore engages with the threaded shaft.

6. The flash drive of claim 5, wherein an engagement direction between the positioning pin and the USB flash drive body is perpendicular to a sliding direction of the sliding seat within the housing.

7. The flash drive of claim 2, wherein the manually rotatable shaft comprises a shaft body; wherein a through-hole is coaxially formed in the shaft body;
wherein an internal shoulder is integrally formed on an inner surface of the through-hole; and
wherein the internal shoulder abuts the threaded shaft.

8. The flash drive of claim 7, wherein the manually rotatable shaft is fixed to the threaded shaft by a screw.

9. The flash drive of claim 2, wherein the tool is removably attached to an end of the slider assembly opposite the USB flash drive body, and the tool comprises a glass breaker or a screwdriver.

10. The flash drive of claim 9, wherein the tool is threadedly engaged within the through-hole of the manually rotatable shaft.

11. The flash drive of claim 9, further comprising an end cap removably connected to the manually rotatable shaft by a snap-fit,
wherein a first alignment mark is disposed on the manually rotatable shaft, a second alignment mark is disposed on the end cap; and
wherein the end cap covers the tool when the first alignment mark is not aligned with the second alignment mark, wherein the snap-fit is released when the first alignment mark aligns with the second alignment mark.

12. The flash drive of claim 11, wherein outer surface of the manually rotatable shaft or the end cap comprises an anti-slip texture.

13. The flash drive of claim 1, wherein the housing comprises an indicator light configured to illuminate when the USB connector is electrically connected to an external device.

14. The flash drive of claim 1, wherein the housing comprises an upper housing and a lower housing that are detachably connected, the upper housing and the lower housing forming the sliding cavity when assembled.

15. A flash drive, comprising:
a housing defining an interior cavity and an opening at a first end;
a USB connector movably disposed within the housing and oriented toward the opening;
a sliding mechanism configured to translate the USB connector between a retracted position, in which the USB connector is enclosed within the housing, and an extended position, in which the USB connector protrudes through the opening; and
a tool integrally connected to a portion of the sliding mechanism, wherein the tool is accessible at a second end of the housing opposite the opening and is configured to perform a non-data-related physical function.

16. The flash drive of claim 15, wherein the sliding mechanism comprises a threaded shaft and a manually rotatable shaft, and wherein rotation of the manually rotatable shaft causes the threaded shaft to drive the USB connector to translate between the retracted position and the extended position.

17. The flash drive of claim 15, wherein the tool is removably secured to the manually rotatable shaft by a threaded connection, and wherein the tool is configured to be interchangeable.

18. A flash drive, comprising:
a housing having an opening at one end and an internal channel extending along a longitudinal axis;
a USB storage assembly positioned within the internal channel and including a USB connector aligned with the opening; and
a user-actuated slider disposed on an exterior surface of the housing and mechanically linked to the USB storage assembly, the slider being movable between a first position and a second position to cause the USB connector to move between a stored position within the housing and an exposed position extending from the opening, wherein the user-actuated slider includes a rotatable shaft configured to convert rotational input from a user into linear translation of the USB storage assembly.

19. The flash drive of claim 18, further comprising a tool removably secured to an end of the user-actuated slider opposite to the USB storage assembly, wherein the tool is configured to perform a non-data-related physical function.

20. The flash drive of claim 19, further comprising an end cap removably connected to the end of the user-actuated slider opposite to the USB storage assembly, wherein the end cap is configured to cover the tool when the tool is not in use.
